(19) United States
(12) Patent Application Publication
(10) Pub. No.: US 2006/0208387 A1
(43) Pub. Date: Sep. 21, 2006

(54) Moulded bodies consisting of biological fibrous material and plastic

(76) Inventor: Harald Zodl, Wien (AT)

Correspondence Address: OSTROLENK FABER GERB & SOFFEN, 1180 AVENUE OF THE AMERICAS, NEW YORK, NY, 100368403, US

(21) Appl. No.: 10/552,940

(22) PCT Filed: Mar. 25, 2004
(86) PCT No.: PCT/EP04/03162

§ 371 Date: Nov. 16, 2005

(30) Foreign Application Priority Data
Apr. 14, 2003 (AT) A573/2003

(51) Int. Cl. D04H 1/00; B29C 59/00

(52) U.S. Cl. 264/122

(57) ABSTRACT

The invention relates to a molded body which comprises at least one plant- or animal-derived fiber material, at least one plastic, and at least one water-binding biopolymer, where its water content is >8.0% by weight, preferably 8.5% by weight, particularly preferably 9.0% by weight, and it is not expanded.

The invention relates to a molded body comprising biological fiber material and plastic. In particular the invention relates to a molded body composed of plant- and/or animal-derived fiber material, with at least one plastic and with at least one water-binding biopolymer. The invention further relates to a process for production of this molded body.

Interest in natural fiber materials has risen sharply in recent years in the plastics industry. In particular, the use of wood fibers, wood flour, or wood chips in “wood like plastic” or “plastic timber” materials, processed by extrusion technology to give profiles, has experienced a real boom.

Nevertheless, a problem not hitherto satisfactorily solved is that natural fiber materials, in particular wood, always retain a certain amount of residual water, even after air-drying, and this often impairs the quality of profiles manufactured from plastic and from wood components. In particular in the case of profiles manufactured at relatively high output speed, uncontrollable blisters and expansion zones occur, their cause being that, after plastic or thermoplastic forming of the raw material mixture, during the subsequent step of shaping the molding composition to give the molded body the associated depressurization, e.g. at the outlet from the die of an extrusion unit, results in sudden evaporation of the residual water present out of the molding composition. A result of this can even be that this type of profile can lose its cohesion at relatively high extrusion temperatures and extrusion speeds. Many of the processes disclosed hitherto start from a requirement that the water content of the raw materials used has to be minimized prior to introduction into the actual final extrusion step in which the finished profile is produced. To this end, the natural materials are usually prepared for use via excessive conventional drying prior to the extrusion process, or two extrusion units are installed in series in an attempt to achieve loss of water by evaporation between the two assemblies. The first extrusion unit is actually used only as a dryer here. The conventional materials obtained by these processes have a water content of from about 0.2 to 0.5% by weight, but nevertheless are expanded and have gas-filled cavities (bubbles).

Processes have also been proposed in which the residual water is eliminated or consumed to a desired extent by chemical reactions via addition of a synthetic resin (JP 6123306) or by inorganic substances, such as CaO and CaSO4 (JP 6143213, JP 52025844, JP 52025843, JP 57075851, and EP 913243). However, in all of these cases the residual water still remaining will give molded bodies having some degree of expansion in the course of an extrusion process.

The Austrian patent application AT-A 1682/2001 discloses molded bodies produced via extrusion whose compactness and coherence depends on the water content of the fiber material used, and also on the use of additional water-binding inorganic, and also if necessary organic, additives. No dimensionally accurate molded body could be produced until simultaneous use was made of wood shavings dried at high cost to 1.5% by weight water content and 8% by weight of granular gypsum, highly calcined. If wood shavings with 2% by weight water content were used, despite the use of 6% by weight of calcium oxide, it was impossible to produce a molded body with improved profile surface until an additional 8% by weight of maize flour were also used.

A disadvantage of the molded body disclosed in AT-A 1682/2001 is that, for production of a coherent, dimensionally accurate molded body, it is essential to dry the wood fiber material used at high cost, and even then it is impossible to dispense with the use of inorganic water-binding substances and, respectively, the additional use of organic water-binding substances.

An advantage with the use of undried material is that it is possible, in a simple and cost-effective manner, to produce molded bodies whose moisture level is in equilibrium with the humidity occurring typically in a Central European climate (from 20 to 80% by weight). These molded bodies are particularly dimensionally stable.

An object of the present invention is therefore to provide a molded body for which it is possible to dispense with this type of complicated predrying of the biological fiber material used.

According to the invention, this object is now achieved by a molded body comprising at least one plant- or animal-derived fiber material, at least one plastic, and at least one water-binding biopolymer when its water content is ≧8.0% by weight, preferably ≧8.5% by weight, particularly preferably >9.0% by weight and it is not expanded.

In complete contrast to the teaching known from the prior art, it has been found that, even when using a raw material mixture with such a high residual moisture level that the resultant molded body has a water content of >8.0% by weight, a dimensionally accurate molded body with a fully satisfactory surface can be produced.

In order to achieve the object set according to the invention a first requirement is to maintain the water content of the molded body above 8.0% by weight, because this is the only way of ensuring that it is possible to dispense with the complicated predrying described in the prior art.

A further requirement is that the molded body is not expanded. For the purposes of the present invention, an non-expanded molded body is a molded body which in the course of its production experiences less than 10% volume growth via the shaping step, i.e. has an expansion index of less than 1.1, in particular from 1.00 to 1.09. The expansion index can be adjusted during production of the molded body via selection of the shaping process and, respectively, during the selection of the process conditions during the shaping process.

For the purposes of the present invention, the term “molded body” means the product of a molding process, such as compression molding, pelletizing, granulating, injection molding, profile extrusion, etc.

According to one advantageous embodiment of the invention, the water content of the molded body is up to 15% by weight, preferably up to 12% by weight.

Although in principle it is also possible at higher water contents to produce an non-expanded molded body, production then often becomes uneconomic because of the restrictions that have to be complied with during the shaping of the molded body.

Fiber materials which can be used are in principle any of the materials of plant origin or of animal origin which comprise fibrous polymers and thus can give the molded bodies good strength properties. Examples of suitable plant-derived fiber materials are wood fibers, wood flour, wood chips, cellulose-containing materials, such as waste paper, hemp, straw, flax, or other agricultural fiber materials, e.g. comminuted plant parts, for example rice husks or sugarcane waste. It is also possible to use animal-derived fiber material, for example in the form of waste leather. In order to permit production of minimum-cost molded bodies, it is also possible to use mixtures of individual materials from those mentioned above, or of two or more of those materials—depending on availability. The amount of the fiber materials present in the molded bodies is from 5 to 95% by weight, in particular from 30 to 80% by weight.

The inventive molded bodies comprise at least one plastic, which may be either a thermoset or a thermoplastic. The nature of the plastic used also depends on the intended use of the molded body produced. Examples of suitable plastics are polyethylene, polypropylene, PVC, melamine, polyurethane, polyester, polyamide, polymethyl methacrylate, polyvinyl acetate, polystyrene, polycarbonate, polybutene, or mixture of the abovementioned plastics. Any type of random copolymer, block copolymer, or else graft copolymer is also encompassed here. The amount of the plastic or plastics mixture present in the inventive molded bodies is from 2 to 90% by weight, in particular from 5 to 50% by weight.

The inventive molded bodies further comprise at least one biopolymer which is suitable for binding water, for example by interacting with water at an elevated temperature and incorporating water. The biopolymer binds at least some of the water, and this is therefore not available for evaporation during the shaping of the molded body. Examples of suitable biopolymers are starch or starch-containing comminuted field crops, such as maize (corn) or rice in the form of flour. Other suitable materials are not only proteins, such as gluten, collagen, keratin, but also lignins, pectins, and hemicelluloses, which are similar to starch in their ability to bind water. The amount of the biopolymer present in the inventive molded bodies is from 5 to 50% by weight, in particular from 10 to 30% by weight.

Other auxiliaries conventional in plastics technology can, if appropriate, be added to the raw material mixture, examples being plasticizers, fillers, adhesion promoters, dyes, lubricants, heat stabilizers and/or UV stabilizers, antioxidants, or flame retardants, the amount being from 0.2 to 20% by weight, preferably from 0.5 to 10% by weight, based on the total weight of the raw material mixture.

The density of the inventive molded bodies, depending on the nature and amount of the raw materials used, is from 0.8 to 2.0 g/cm³, preferably from 1.0 to 1.5 g/cm³.

In order to ensure that when the inventive molded bodies are shaped the water present therein does not evaporate, or does not evaporate too rapidly, leading to molded bodies with impaired surface or to expanded molded bodies with undesired mechanical properties, it is necessary to produce the molded bodies via a shaping process that takes place under pressure. The pressures arising or to be exerted here are, depending on the shaping process, up to 500 bar (extrusion) or up to 2000 bar (injection molded body). In individual cases even higher pressures can be exerted.

The raw material mixture may optionally be subjected, prior to the shaping process, to a plastic or thermoplastic forming process, likewise under pressure, for example in an extruder.

For the shaping of the inventive molded bodies, the processes preferably used are compression molding, pelletizing, injection-compression molding, or injection molding.

The invention further provides a process for producing the inventive molded bodies. To produce the molded bodies,
plant- and/or animal-derived fiber material whose moisture content is from 5 to 20% by weight, preferably from 8 to 15% by weight, is mixed with at least one plastic, with at least one water-binding biopolymer, and, if appropriate, with water to give a raw material mixture whose moisture content is >8% by weight, preferably up to 20% by weight, particularly preferably up to 15% by weight,
the raw material mixture is, if appropriate, heated,
the raw material mixture, if appropriate heated, is, if appropriate, formed—plastically or thermo-plastically under increased pressure, and also, if appropriate, with increased temperature—to give a molding composition and
the raw material mixture, if appropriate heated, or the molding composition is shaped under pressure, and also, if appropriate, with increased temperature, to give a non-expanded molded body.

In the case of some raw material mixtures, it is advantageous to add water to adjust the moisture level in order to obtain a moisture content of >% by weight of the raw material mixture.

In one version of the inventive process, the raw material mixture is prepared via dry mixing of the individual components and the raw material mixture is then introduced into a pellet press (similar to a pellet press for production of wood pellets). A non-expanded molded body is produced, in this case a pellet, by arriving at a suitable selection of the process parameters, in particular of the processing speed. During pellet production, the raw material mixture is pressed through the holes of a die. Internal friction processes cause heating of the raw material mixture during this process. The process can also be influenced via the specific selection of the die. By way of example, a die of relatively high thickness permits production of non-expanded molded bodies even at relatively high moisture contents—because of the higher pressures arising during passage through the holes.

It is preferable that the raw material mixture is not heated before being introduced into the pellet press. However, for some raw material mixtures it can be necessary to preheat the mixtures to about 70-80° C. in order to permit fully satisfactory pellet production. It is preferable that no heat is introduced in the pellet press itself.

Other preferred production processes for the inventive molded bodies in addition to pelletizing are compression molding, injection-compression molding, and injection molding.

In the case of injection molding, the raw material mixture is likewise first premixed in dry form. The raw material mixture is then applied to an extruder in which the raw material mixture is subjected to thermoplastic forming under pressure, the temperatures of the composition being from 100 to 200° C., and is formed to give a molding composition.

In the extruder, simultaneous feed of the raw materials and retraction of the screw builds a material cushion which is then injected into the mold under pressure, using up to 2000 bar. The mold includes both the gating system and the cavities. The gating system can be formed by cold- or hot-runners or combinations thereof. A cold-runner is preferred on grounds of cost.

Downstream of the gating system are the cavities, to which the molding composition is charged under pressure. The mold remains closed until the molding composition solidifies. Once the molding composition has solidified, the mold is opened and the injection molded body is demolded.

The inventive molded bodies can either be used simply as they stand wherever parts made purely from plastic or purely from wood are nowadays used, or may be processed in a manner known per se in a subsequent processing step to give molded bodies of this type. Examples of molded bodies of this type are: edgings, decorative and other strips, facade components, floorboards, fencing elements, cable ducts, panels, hollow profiles and other profiles, cladding and packaging materials.

### EXAMPLES

### Comparative Example 1

300 kg/h of the following raw material mixture were fed into a twin-screw extruder:

73% by weight of wood shavings (water content 10.5% by weight)

10% by weight of polypropylene

15% by weight of maize flour (water content 11.5% by weight)

2% by weight of adhesion promoter (maleic-anhydride-grafted PP)

The moisture content of the raw material mixture was adjusted to 12% by weight via addition of water.

The molded body produced comprised pellets. The pelletizing die used comprised a perforated plate with 32 holes each of diameter 3.0 mm.

Extrusion conditions

| | |
|---|---|
| Feed zone: | 150° C. |
| Zone 1: | 160° C. |
| Zone 2: | 170° C. |
| Zone 3: | 180° C. |
| Zone 4: | 180° C. |
| Die inlet: | 170° C. |
| Die: | 160° C. |
| Screw: | 90° C. |
| Temperature of composition: | 190° C. |
| Screw rotation rate: | 35 rpm |
| Exit velocity of pellet strand: | 4 m/min |

The pellets thus produced had a moisture content of 9% by weight. However, the average diameter of the pellets was 3.3 mm. On the basis of the original hole diameter (3.0 mm) this therefore corresponds to 21% volume growth. The molded body produced in this way have therefore been expanded.

### Example 2

300 kg/h of the following raw material mixture were fed into a pelletizer:

73% by weight of wood shavings (water content 10.5% by weight)

10% by weight of polypropylene

15% by weight of maize flour (water content 11.5% by weight)

2% by weight of adhesion promoter (maleic-anhydride-grafted PP)

The moisture content of the raw material mixture was adjusted to 12% by weight via addition of water.

A perforated plate with some hundreds of holes, each hole diameter being 6.0 mm, was used. The edge-runner gap in the pelletizer was set to 0.2 mm. The current consumed by the pelletizer was from 50 to 60 A.

The moisture level of the pellets produced in this way was 9% by weight. The average pellet diameter was 6.0 mm (expansion index=1.0).

### Example 3

300 kg/h of the following raw material mixture were fed into a pelletizer:

72% by weight of wood shavings (water content 10.5% by weight)

10% by weight of polyvinyl acetate

15% by weight of maize flour (water content 11.5% by weight)

1% by weight of titanium dioxide

2% by weight of Ca stearate

The moisture content of the raw material mixture was adjusted to 12% by weight via addition of water.

A perforating plate with some hundreds of holes, each hole diameter being 6.0 mm, was used. The edge-runner gap in the pelletizer was set to 0.2 mm. The current consumed by the pelletizer was from 50 to 60 A.

The moisture level of the pellets produced in this way was 10% by weight. The average pellet diameter was 6.1 mm (expansion index=1.034).

### Example 4

Pellets produced as in example 2 are fed into a twin-screw extruder (130 kg/h) and a window-frame profile was extruded from this material.

Extrusion conditions

| | |
|---|---|
| Feed zone: | 150° C. |
| Zone 1: | 160° C. |
| Zone 2: | 170° C. |
| Zone 3: | 180° C. |
| Die inlet: | 160° C. |
| Die: | 160° C. |
| Screw: | 130° C. |
| Temperature of composition: | 180° C. |
| Screw rotation rate: | 12 rpm |
| Exit velocity of profile: | 3 m/min |
| Moisture content of profile: | 9% by weight, |
| Density: | 1.3 g/cm³ |

The cross-sectional area of the finished profile is identical with the cross section of the extrusion die. The expansion index is therefore 1.0.

### Example 5

Pellets produced as in example 3 are fed into a twin-screw extruder (300 kg/h) and a panel profile was extruded from this material.

Extrusion conditions

| | |
|---|---|
| Feed zone: | 80° C. |
| Zone 1: | 120° C. |
| Zone 2: | 130° C. |
| Zone 3: | 110° C. |
| Die inlet: | 115° C. |
| Die: | 130° C. |
| Screw: | 60° C. |
| Temperature of composition: | 130° C. |
| Screw rotation rate: | 30 rpm |
| Exit velocity of pellet strand: | 3.5 min |
| Moisture content of profile: | 10% by weight, |
| Density: | 1.4 g/cm³ |

The cross-sectional area of the finished profile is identical with the cross section of the extrusion die. The expansion index is therefore 1.0.

1. A molded body obtained via a shaping process that takes place under pressure, comprised of:
at least one plant- or animal-derived fiber material,
at least one thermoplastic or thermoset selected from the group consisting of polyethylene, polypropylene, PVC, melamine, polyurethane, polyester, polyamide, polymethyl meth-acrylate, polyvinyl acetate, polystyrene, poly-carbonate, and polybutene; and
at least one water-binding biopolymer,
wherein water content of the body immediately after its production is >8.0% by weight, and the body is not expanded.

2. The molded body as claimed in claim 1, wherein the water content is up to 15% by weight.

3. The molded body as claimed in claim 1, which comprises an amount of from 5 to 95% by weight.

4. The molded body as claimed in claim 1, wherein the amount of the thermoplastic or thermoset or of a mixture thereof is from 2 to 90% by weight.

5. The molded body as claimed in claim 1, which comprises an amount of from 5 to 50% by weight, of water-binding biopolymer.

6. The molded body as claimed in claim 1, having a density of from 0.8 to 2.0 g/cm³.

7. The molded body as claimed in claim 1, produced via a shaping process that takes place under pressure and after a plastic or thermoplastic forming process under pressure.

8. The molded body as claimed in claim 7, produced via compression molding, pelletizing, injection-compression molding, or injection molding.

9. A process for producing a molded body comprising the steps of:
mixing raw materials comprised of plant- or animal-derived fiber material having a moisture content from 5 to 20% by weight, at least one thermoplastic or thermoset selected from the group consisting of polyethylene, polypropylene, PVC, melamine, polyurethane, polyester, polyamide, polymethyl methacrylate, polyvinyl acetate, polystyrene, polycarbonate, and polybutene, and of at least one water-binding biopolymer, to give a raw material mixture having a moisture content >8% by weight
and shaping the raw material mixture under pressure to produce a non-expanded molded body.

10. The process as claimed in claim 9, further comprising shaping the ingredients under pressure via compression molding, pelletizing, injection-compression molding, or injection molding.

11. The molded body of claim 1, wherein based on the total weight, the body is comprised 0.2 to 20% by weight of plasticizers, fillers, adhesion promoters, lubricants, heat stabilizers and/or UV stabilizers, antioxidants, or flame retardants.

12. The process as claimed in claim 9, wherein based on the total weight, the raw material comprises from 0.2 to 20% by weight of plasticizers, fillers, adhesion promoters, lubricants, heat stabilizers and/or UV stabilizers, antioxidants, or flame retardants.

13. The molded body as claimed in claim 3, wherein the fiber material is selected from the group consisting of wood fibers, wood flour, wood chips, and cellulose-containing materials, wherein the cellulose containing material is selected from the group consisting of waste paper, hemp, straw, flax, agricultural fiber materials, and mixtures thereof.

14. The process claimed in claim 5, wherein the water-binding polymer is selected from the group consisting of starch, starch-containing plant parts, pectin, lignin, hemicellulose, chitin, and mixtures thereof.

15. The process as claimed in claim 9, further comprising heating the raw material mixture.

16. The process as claimed in claim 15, further comprising applying pressure to the raw material mixture sufficient for producing a molding composition plastically or thermoplastically.

17. The process as claimed in claim 16, further comprising increasing the temperature of the raw material mixture during the production of the molding composition.

18. The process as claimed in claim 9, further comprising supplying increased temperature during the shaping of the raw material mixture.

19. The process as claimed in claim 15, wherein the raw material shaping is performed under an increased temperature.

20. The process as claimed in claim 16, wherein the pressure is applied under an increased temperature.

21. The process as claimed in claim 17, wherein increased temperature is supplied during the shaping of the raw material mixture.

22. The process as claimed in claim 9, further comprising mixing water in the raw material mixture.

23. The process as claimed in claim 15, further comprising mixing water in the raw material mixture.

24. The process as claimed in claim 16, further comprising mixing water in the raw material mixture.

25. The process as claimed in claim 17, further comprising mixing water in the raw material mixture.

26. The process as claimed in claim 18, further comprising mixing water in the raw material mixture.

27. The process as claimed in claim 19, further comprising mixing water in the raw material mixture.

28. The process as claimed in claim 20, further comprising mixing water in the raw material mixture.

29. The process as claimed in claim 21, further comprising mixing water in the raw material mixture.
